(19) United States
(12) Patent Application Publication
(10) Pub. No.: US 2026/0135157 A1
(43) Pub. Date: May 14, 2026

(54) WOUND ELECTRODE ASSEMBLY

(71) Applicant: TOYOTA JIDOSHA KABUSHIKI KAISHA, Toyota-shi (JP)

(72) Inventors: Mitsuru TATEISHI, Toyota-shi (JP); Masashi UEDA, Toyota-shi (JP); Jun IZUMI, Toyota-shi (JP); Shizuka MASUOKA, Nagoya-shi (JP); Aya SATO, Nagoya-shi (JP); Keitaro MACHIDA, Hamamatsu-shi (JP); Yuji KATAYAMA, Okazaki-shi (JP); Tatsuya YAMAMOTO, Toyohashi-shi (JP)

(73) Assignee: TOYOTA JIDOSHA KABUSHIKI KAISHA, Toyota-shi (JP)

(21) Appl. No.: 19/371,334

(22) Filed: Oct. 28, 2025

(30) Foreign Application Priority Data
Nov. 14, 2024 (JP) 2024-198923

(51) Int. Cl. H01M 10/0587; H01M 50/121

(52) U.S. Cl. CPC H01M 10/0587; H01M 50/121

(57) ABSTRACT

A wound electrode assembly in which first and second electrode members are wound in a flat shape with a separator interposed therebetween includes a pair of flat portions, and a pair of curved portions each connecting ends of the flat portions. The first electrode member includes a first resin substrate, a first conductive layer provided on a surface of the first resin substrate, and a first active material layer provided on a main surface of the first conductive layer located on the opposite side of the first conductive layer from the first resin substrate. The first resin substrate is made of a thermosetting resin. A portion of the first resin substrate located in the flat portions is in a cured state in which the thermosetting resin is cured. A portion of the first resin substrate located in the curved portions includes a semi-cured region where the thermosetting resin is semi-cured.

### CROSS-REFERENCE TO RELATED APPLICATION

This application claims priority to Japanese Patent Application No. 2024-198923 filed on Nov. 14, 2024. The disclosure of the above-identified application, including the specification, drawings, and claims, is incorporated by reference herein in its entirety.

### BACKGROUND

### 1. Technical Field

The present disclosure relates to wound electrode assemblies.

### 2. Description of Related Art

Japanese Unexamined Patent Application Publication No. 2019-096592 (JP 2019-096592 A) discloses a wound electrode assembly in which a cathode member and an anode member, both in the form of a sheet, are wound with a separator interposed therebetween. In this wound electrode assembly, an electrode member in which a conductive layer and an active material layer are laminated in this order on the surface of an insulating substrate is used as at least one of the cathode member and the anode member. The conductive layer includes a first portion coated with the active material layer and a second portion protruding from the first portion. A through hole penetrating in the thickness direction is provided in the second portion and a portion of the insulating substrate corresponding to the second portion. In the present specification, the term “conductive” means “electrically conductive” unless specified otherwise.

### SUMMARY

In a wound electrode assembly, when a resin substrate having conductive layers on both sides is used as a substrate supporting an active material layer, there is a concern that circumferential creep characteristics may deteriorate due to the resin substrate, resulting in loose winding.

The present disclosure has been made in consideration of the above issue, and an object of the present disclosure is to provide a wound electrode assembly that can reduce the possibility of loose winding.

A wound electrode assembly according to the present disclosure is a wound electrode assembly in which a first electrode member and a second electrode member having a different polarity from the first electrode member are wound in a flat shape with a separator interposed therebetween. The wound electrode assembly includes a pair of flat portions and a pair of curved portions. The flat portions face each other across a winding center. One of the curved portions connects ends on one side of the flat portions, and the other curved portion connects ends on the other side of the flat portions. In the wound electrode assembly, the first electrode member includes a first resin substrate, a first conductive layer provided on a surface of the first resin substrate, and a first active material layer provided on a main surface of the first conductive layer. The main surface is located on the opposite side of the first conductive layer from the first resin substrate. The first resin substrate is made of a thermosetting resin. A portion of the first resin substrate located in the flat portions is in a cured state in which the thermosetting resin is cured. A portion of the first resin substrate located in the curved portions includes a semi-cured region where the thermosetting resin is semi-cured.

In the wound electrode assembly with the above configuration, the thermosetting resin is in the cured state in the flat portions. Accordingly, elongation of the first resin substrate is suppressed, and the possibility of loose winding of the wound electrode assembly can be reduced.

In the wound electrode assembly according to the present disclosure, outermost portions of the curved portions may have a larger proportion of the semi-cured region than innermost portions of the curved portions.

With the above configuration, in the curved portions, the proportion of the semi-cured region increases toward the outer side. Therefore, the outer sides of the curved portions that are more likely to be subjected to loads become more deformable. It is therefore possible to suppress breakage of the curved portions when a load is applied.

In the wound electrode assembly according to the present disclosure, the thermosetting resin may have a curing temperature higher than 110° C.

In the above configuration, the curing temperature of the thermosetting resin is higher than 110° C. that is the drying temperature of the wound electrode assembly. This reliably allows the semi-cured region to remain in the curved portions.

In the wound electrode assembly according to the present disclosure, the second electrode member may include a metal substrate and a second active material layer provided on a surface of the metal substrate.

With the above configuration, even in a configuration in which the second electrode member includes the metal substrate and the second active material layer, elongation is suppressed and the possibility of loose winding can be reduced because the thermosetting resin in the first electrode member is in the cured state in the flat portions.

In the wound electrode assembly according to the present disclosure, the second electrode member may include a second resin substrate, a second conductive layer provided on a surface of the second resin substrate, and a second active material layer provided on a main surface of the second conductive layer. The main surface is located on the opposite side of the second conductive layer from the second resin substrate.

With the above configuration, even in a configuration in which the second electrode member includes the second resin substrate, the second conductive layer, and the second active material layer, elongation is suppressed and the possibility of loose winding can be reduced because the thermosetting resin in the first electrode member is in the cured state in the flat portions.

The present disclosure can provide a wound electrode assembly that can reduce the possibility of loose winding.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to a first embodiment;

FIG. 2 is an exploded perspective view of the battery according to the first embodiment;

FIG. 3 is a sectional view of the battery in FIG. 1, taken along line III-III and viewed in the direction of the arrows;

FIG. 4 is a cross-sectional view of a wound electrode assembly in FIG. 3, taken along line IV-IV and viewed in the direction of the arrows;

FIG. 5 is a sectional view of a first electrode member of the wound electrode assembly in FIG. 3 in an unwound state; and

FIG. 6 is a sectional view of a second electrode member of a wound electrode assembly according to a second embodiment in an unwound state.

### DETAILED DESCRIPTION OF EMBODIMENTS

Hereinafter, embodiments of the present disclosure will be described in detail with reference to the drawings. In the following embodiments, the same or common portions are denoted by the same signs throughout the drawings, and description thereof will not be repeated.

### First Embodiment

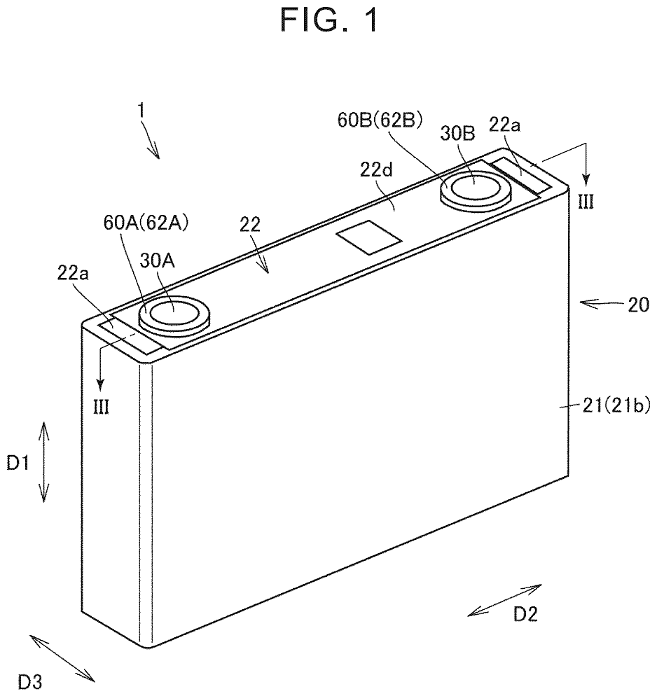

FIG. 1 is a perspective view of a battery according to a first embodiment. As shown in FIG. 1, the battery 1 according to the first embodiment is a prismatic battery. The battery 1 may be a secondary battery configured to be charged and discharged such as a lithium-ion battery or a nickel metal hydride battery. The battery 1 may be used, for example, as a cell included in an energy storage module mounted on an electrified vehicle.

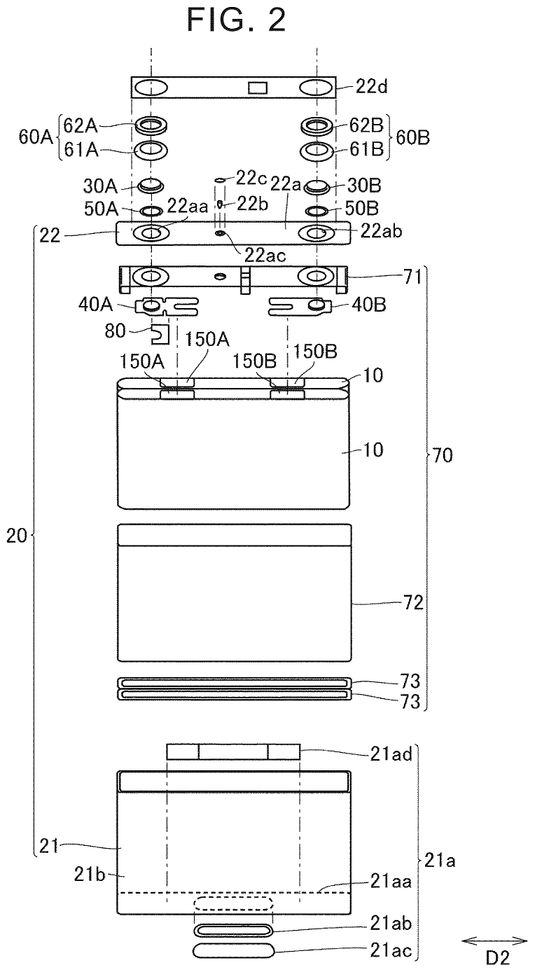

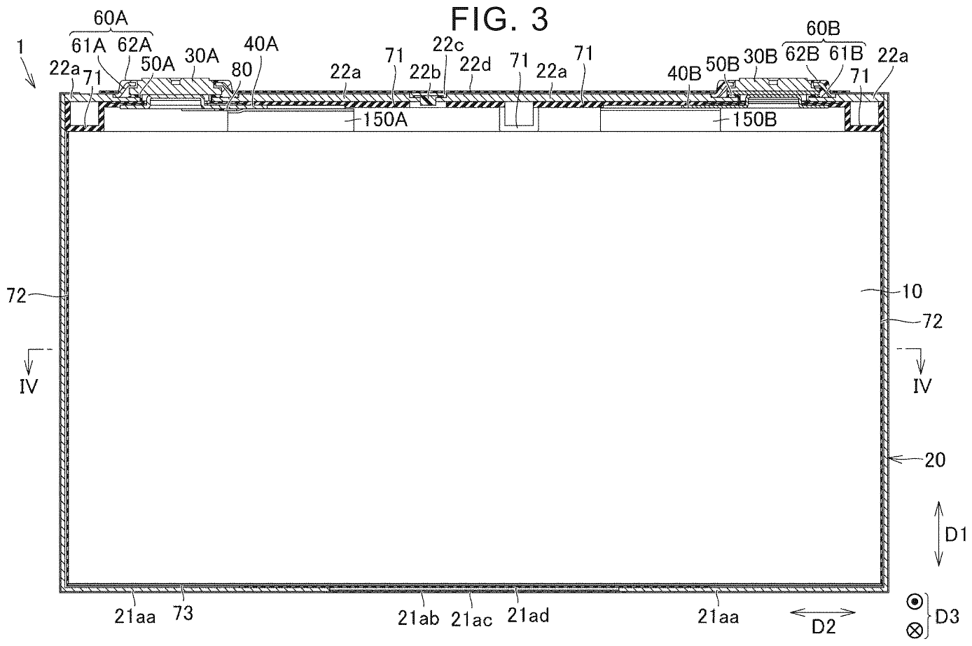

FIG. 2 is an exploded perspective view of the battery according to the first embodiment. FIG. 3 is a sectional view of the battery in FIG. 1, taken along line III-III and viewed in the direction of the arrows. As shown in FIGS. 1 to 3, the battery 1 of the first embodiment includes a plurality of wound electrode assemblies 10, a case 20, a first external terminal 30A, a second external terminal 30B, a first connecting member 40A, a second connecting member 40B, a first seal ring 50A, a second seal ring 50B, a first terminal support portion 60A, a second terminal support portion 60B, an insulating member 70, and a fuse protection portion 80.

The case 20 is conductive. A conductive portion of the case 20 is made of, for example, a metal such as aluminum. The case 20 houses the wound electrode assemblies 10. The case 20 also contains an electrolyte solution, not shown.

The case 20 includes a case body 21 and a lid 22. The case body 21 includes a bottom wall 21a and a peripheral wall 21b standing from the bottom wall 21a.

The bottom wall 21a includes a bottom body 21aa, a pressure relief valve 21ab, an outer protective film 21ac, and an inner protective film 21ad. The peripheral wall 21b stands from the bottom body 21aa. The pressure relief valve 21ab is provided in the bottom body 21aa. The outer protective film 21ac covers the pressure relief valve 21ab from the outside. The inner protective film covers the pressure relief valve 21ab from the inside. The bottom body 21aa and the pressure relief valve 21ab are made of a metal such as aluminum.

An opening is formed at the upper end of the peripheral wall 21b. The peripheral wall 21b has a substantially rectangular outer shape when viewed from the opening direction of the opening (the direction normal to the opening plane). The opening and the bottom wall 21a are arranged in a first direction D1. The first direction D1 may be the height direction or the up-down direction of the battery 1. The peripheral wall 21b is made of a metal such as aluminum.

The lid 22 includes a lid body 22a, a sealing plug 22b, a plug cover 22c, and an insulating cover 22d.

The lid body 22a is joined to the peripheral wall 21b by welding etc. so as to close the opening of the peripheral wall 21b. The lid body 22a has with a first connecting hole 22aa, a second connecting hole 22ab, and a filling hole 22ac. The filling hole 22ac is a through hole for injecting an electrolyte solution into the case body 21 in a manufacturing process of the battery 1.

The sealing plug 22b seals the filling hole 22ac. The plug cover 22c covers the filling hole 22ac and the sealing plug 22b. The insulating cover 22d covers the filling hole 22ac, the sealing plug 22b, and the plug cover 22c.

The first external terminal 30A and the second external terminal 30B are provided in the battery 1 so as to be exposed to the outside. The first connecting member 40A and the second connecting member 40B are conductive. At least part of the first connecting member 40A and at least part of the second connecting member 40B are disposed inside the case 20.

The first external terminal 30A or the first connecting member 40A is inserted through the first connecting hole 22aa. The first external terminal 30A and the first connecting member 40A are joined together. The first connecting member 40A is joined to the wound electrode assembly 10. Accordingly, the first external terminal 30A is electrically connected to the wound electrode assembly 10.

The second external terminal 30B or the second connecting member 40B is inserted through the second connecting hole 22ab. The second external terminal 30B and the second connecting member 40B are joined together. The second connecting member 40B is joined to the wound electrode assembly 10. Accordingly, the second external terminal 30B is electrically connected to the wound electrode assembly 10.

In the present embodiment, the first external terminal 30A is a cathode terminal, and the second external terminal 30B is an anode terminal. The first external terminal 30A and the second external terminal 30B are arranged in a second direction D2. The second direction D2 is a direction perpendicular to the first direction D1.

The first seal ring 50A is provided along the first connecting hole 22aa. The first seal ring 50A is provided in the gap between the lid body 22a and the first external terminal 30A to seal this gap. The second seal ring 50B is provided along the second connecting hole 22ab. The second seal ring 50B is provided in the gap between the lid body 22a and the second external terminal 30B to seal this gap. The first seal ring 50A and the second seal ring 50B are electrically insulating.

The first terminal support portion 60A is retained by the lid body 22a. The first terminal support portion 60A supports the first external terminal 30A from the outer peripheral side of the first external terminal 30A. The first terminal support portion 60A includes a first retaining ring 61A and a first covering ring 62A. The first retaining ring 61A extends annularly so as to surround the first connecting hole 22aa, and is directly retained by the lid body 22a. The first covering ring 62A covers the first retaining ring 61A. The first retaining ring 61A supports the first external terminal 30A via the first covering ring 62A. The first covering ring 62A is a resin member that is electrically insulating or relatively weakly conductive.

The second terminal support portion 60B is retained by the lid body 22a. The second terminal support portion 60B supports the second external terminal 30B from the outer peripheral side of the second external terminal 30B. The second terminal support portion 60B includes a second retaining ring 61B and a second covering ring 62B. The second retaining ring 61B extends annularly so as to surround the second connecting hole 22ab, and is directly retained by the lid body 22a. The second covering ring 62B covers the second retaining ring 61B. The second retaining ring 61B supports the second external terminal 30B via the second covering ring 62B. The second covering ring 62B is a resin member that is electrically insulating.

The insulating member 70 is electrically insulating. The insulating member 70 is disposed between the wound electrode assemblies 10 and the case 20. The insulating member 70 electrically insulates the wound electrode assemblies 10 from the case 20. The insulating member 70 includes an insulating bracket 71, a peripheral surface insulating portion 72, and a bottom surface insulating portion 73.

The insulating bracket 71 is disposed between the wound electrode assemblies 10 and the lid body 22a. The insulating bracket 71 has relatively high rigidity and is in contact with both the wound electrode assemblies 10 and the lid body 22a. The wound electrode assemblies 10 are thus secured in the case 20 in the first direction D1.

The peripheral surface insulating portion 72 is disposed between the wound electrode assemblies 10 and the peripheral wall 21b. The peripheral surface insulating portion 72 is a member in the form of a film.

The bottom surface insulating portion 73 is disposed between each of the wound electrode assemblies 10 and the bottom wall 21a. The bottom surface insulating portion 73 is a member in the form of a film. In the present embodiment, the bottom surface insulating portion 73 is bonded to the wound electrode assembly 10. The bottom surface insulating portion 73 covers part of the bottom surface of the wound electrode assembly 10. The bottom surface insulating portion 73 may cover the entire bottom surface.

As shown in FIG. 2, the battery 1 according to the present embodiment includes a plurality of wound electrode assemblies 10. The battery 1 typically includes two wound electrode assemblies 10. The wound electrode assemblies 10 are arranged in a third direction D3. The third direction D3 is a direction perpendicular to both the first direction D1 and the second direction D2. The peripheral surface insulating portion 72 may integrally cover the wound electrode assemblies 10 such that the wound electrode assemblies 10 are secured together.

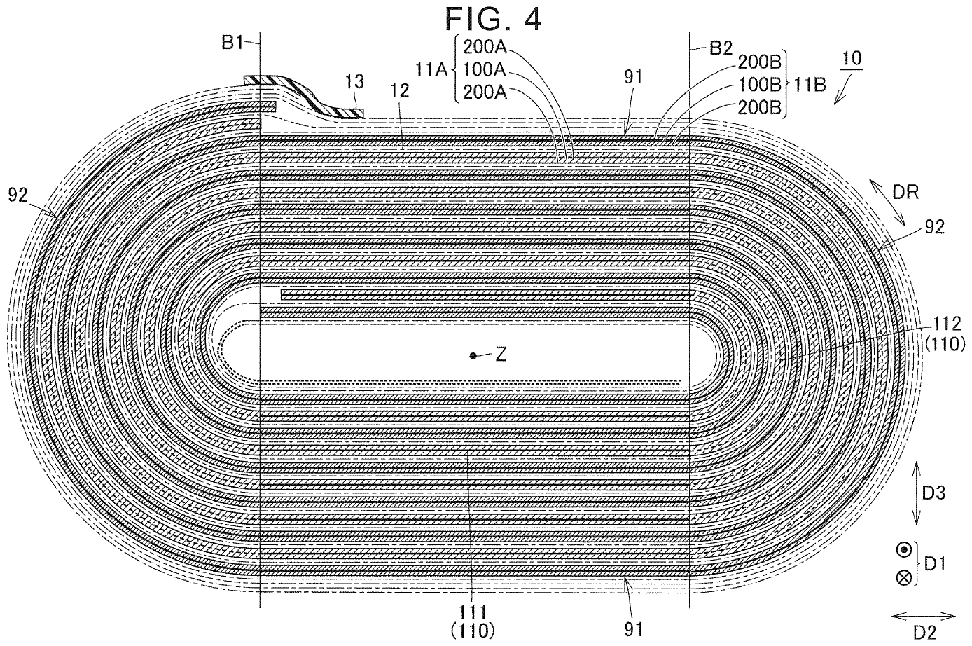

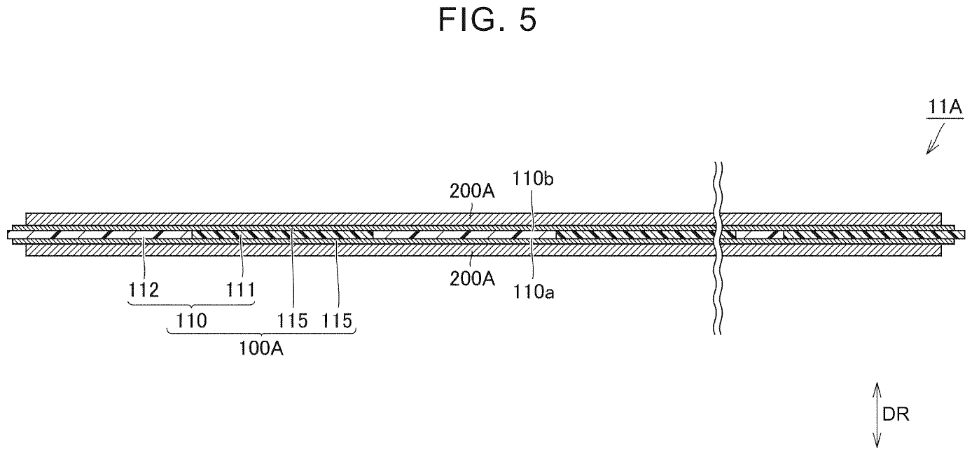

The wound electrode assembly 10 is provided with a plurality of first tabs 150A and a plurality of second tabs 150B. A first end of each of the first tabs 150A is connected to a first conductive layer 115 (see FIG. 5) of a first electrode member 11A (see FIG. 4) described later. A second end of each of the first tabs 150A is joined to the first connecting member 40A by ultrasonic welding etc.

A first end of each of the second tabs 150B is connected to a second substrate 100B of a second electrode member 11B (see FIG. 4) described later. A second end of each of the second tabs 150B is joined to the second connecting member 40B by ultrasonic welding etc.

FIG. 4 is a cross-sectional view of the wound electrode assembly in FIG. 3, taken along line IV-IV and viewed in the direction of the arrows. The wound electrode assembly 10 includes the first electrode member 11A, the second electrode member 11B, a separator 12, and a tape member 13. In the wound electrode assembly 10, the first electrode member 11A, the second electrode member 11B, and the separator 12 are wound around a winding axis Z. In FIG. 4, the separator 12 is schematically shown by long dashed short dashed lines, and a second portion 112 (see FIG. 5) described later is schematically shown by dashed lines.

The first electrode member 11A and the second electrode member 11B are in the form of a sheet. The wound electrode assembly 10 is formed by winding the first electrode member 11A and the second electrode member 11B with one or more separators 12 interposed therebetween. The first electrode member 11A is, for example, a cathode, and the second electrode member 11B is an anode.

The first electrode member 11A includes a first substrate 100A and a first active material layer 200A. The first active material layer 200A has the same polarity as the first electrode member 11A. The first active material layer 200A is, for example, a cathode active material layer. A known material can be used as the cathode active material layer.

The first active material layer 200A is provided on the front and back surfaces of the first substrate 100A. The detailed structure of the first substrate 100A will be described later with reference to FIG. 5.

The second electrode member 11B includes the second substrate 100B and a second active material layer 200B. The second active material layer 200B has the same polarity as the second electrode member 11B. The second active material layer 200B is, for example, an anode active material layer. A known material can be used as the anode active material layer.

In the present embodiment, the second substrate 100B is, for example, a copper-containing metal substrate such as copper foil. The second active material layer 200B is provided on the front and back surfaces of the second substrate 100B.

The separator 12 is provided between the first electrode member 11A and the second electrode member 11B. The separator 12 separates the first electrode member 11A from the second electrode member 11B while allowing ions to travel between the first electrode member 11A and the second electrode member 11B. The ions are, for example, lithium ions. The separator 12 is electrically insulating.

In the wound electrode assembly 10, the separator 12 is located on the radially innermost side. In the wound electrode assembly 10, the separator 12 is located on the radially outermost side. The outer peripheral edge of the separator 12 in a winding direction DR is secured with the tape member 13 placed on the outer peripheral surface of the separator 12.

The separator 12 may contain, for example, a polyolefin-based resin etc. The separator 12 may, for example, be made substantially of a polyolefin-based resin. The polyolefin-based resin may include, for example, at least one selected from the group consisting of polyethylene (PE) and polypropylene (PP).

The wound electrode assembly 10 includes, as its constituent parts, a pair of flat portions 91 and a pair of curved portions 92. The flat portions 91 face each other across the winding center. One of the curved portions 92 connects the ends on one side of the flat portions, and the other curved portion 92 connects the ends on the other side of the flat portions.

The flat portions 91 are in the form of a thin plate parallel to the winding axis Z. In the present embodiment, the flat portions 91 face each other in the third direction D3 that is perpendicular to the direction of the winding axis Z. The curved portions 92 form both ends of the wound electrode assembly 10 in a direction perpendicular to both the thickness direction of the flat portions 91 (third direction D3) and the direction of the winding axis Z. Specifically, the curved portions 92 form both ends of the wound electrode assembly 10 in the second direction D2. Each of the curved portions 92 protrudes outward in the second direction D2. Each of the curved portions 92 is curved outward in the second direction D2.

The boundary B1 between the flat portions 91 and one of the curved portions 92 and the boundary B2 between the flat portions 91 and the other curved portion 92 are linear along the third direction D3 when viewed in a cross-section perpendicular to the winding axis Z.

FIG. 5 is a sectional view of the first electrode member according to the first embodiment. Specifically, FIG. 5 is a sectional view of the first electrode member 11A taken along a plane perpendicular to the second direction D2.

In the first electrode member 11A, the first substrate 100A includes a first resin substrate 110 and the first conductive layer 115. The first resin substrate 110 includes a first portion 111 and the second portion 112. The first portion 111 is located in each of the flat portions 91 in the wound electrode assembly 10. The second portion 112 is located in each of the curved portions 92.

The first resin substrate 110 is made of a thermosetting resin such as phenol resin, epoxy resin, polyurethane resin, unsaturated polyester resin, or polyimide resin.

In order to maintain the wound state of the wound electrode assembly 10, the flat portions 91 are sandwiched between a pair of substantially flat heating portions during manufacturing. Therefore, the heating portions contact the flat portions 91 but are less likely to contact the curved portions 92. In such a case, heat is less likely to be transferred to the curved portions 92. Accordingly, the first portion 111 is in a cured state, and the second portion 112 includes a semi-cured region where the thermosetting resin is semi-cured.

On the other hand, the inner portions of the curved portions 92 tend to trap heat due to lower heat dissipation, whereas the outer portions of the curved portions 92 exhibit higher heat dissipation as they are exposed to ambient air. Therefore, the outermost portions of the curved portions 92 may have a larger proportion of the semi-cured region than the innermost portions of the curved portions 92.

Among the thermosetting resins mentioned above, it is preferable to use a thermosetting resin having a curing temperature higher than 110° C. The manufacturing process of the wound electrode assembly 10 includes a step of drying the wound electrode assembly at 110° C. or lower. Accordingly, the use of a thermosetting resin having a curing temperature higher than the drying temperature of 110° C. reliably allows the semi-cured region to remain in the curved portions 92.

In an unwound state, the first resin substrate 110 is in the form of a sheet extending in the longitudinal direction, and the first portions 111 and the second portions 112 are alternately arranged along the longitudinal direction. The first portions 111 have substantially the same length in the longitudinal direction. On the other hand, the lengths of the second portions 112 in the longitudinal direction gradually decrease from one side toward the other side in the longitudinal direction. The one side in the longitudinal direction corresponds to the outer end side of the wound electrode assembly 10, and the other side in the longitudinal direction corresponds to the inner end side of the wound electrode assembly 10.

The first conductive layer 115 is provided on a surface of the first resin substrate 110. Specifically, the first resin substrate 110 has a first surface 110a and a second surface 110b arranged in its thickness direction, and the first conductive layer 115 is provided on each of the first surface 110a and the second surface 110b.

The first conductive layer 115 is provided so as to extend across all of the first portions 111 and the second portions 112 from the one side to the other side in the longitudinal direction.

The first conductive layer 115 is a metal member containing aluminum. The first conductive layer 115 may be formed on the first surface 110a and the second surface 110b by vapor deposition etc. The first conductive layer 115 may be made of metal foil, and may be bonded to the first surface 110a and the second surface 110b by an adhesive.

The first active material layer 200A is provided on a main surface of the first conductive layer 115 located on the opposite side of the first conductive layer 115 from the first resin substrate 110. Specifically, the first conductive layer 115 provided on each of the first surface 110a and the second surface 110b of the first resin substrate 110 has the main surface on the opposite side from the first resin substrate 110. The first active material layer 200A is provided on the main surface of each of the first conductive layers 115.

As described above, in the wound electrode assembly 10 of the present embodiment, the thermosetting resin in the first electrode member 11A is in the cured state in the flat portions 91. Accordingly, elongation of the first resin substrate 110 is suppressed, and the possibility of loose winding can be reduced.

Moreover, in the curved portions 92, the first resin substrate 110 has the semi-cured region where the thermosetting resin is semi-cured. Accordingly, the curved portions 92 can be softened. It is therefore possible to suppress breakage of the first resin substrate 110 in the curved portions 92.

Furthermore, in the curved portions 92, the proportion of the semi-cured region increases toward the outer side. Therefore, the outer sides of the curved portions 92 that are more likely to be subjected to loads become more deformable. It is therefore possible to suppress breakage of the curved portions 92 when a load is applied.

### Second Embodiment

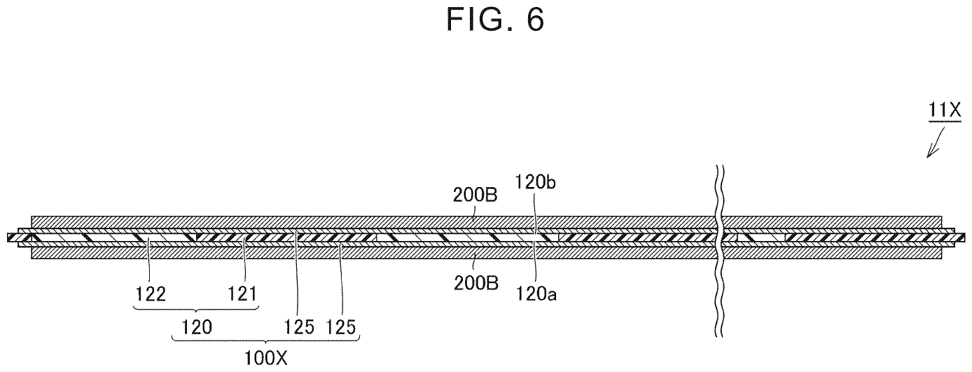

FIG. 6 is a sectional view of a second electrode member of a wound electrode assembly according to a second embodiment in an unwound state. The wound electrode assembly according to the second embodiment will be described with reference to FIG. 6.

As shown in FIG. 6, the wound electrode assembly of the second embodiment is different from the wound electrode assembly 10 of the first embodiment in the configuration of a second electrode member 11X. The configuration of the wound electrode assembly of the second embodiment is otherwise substantially the same as the configuration of the wound electrode assembly 10 of the first embodiment.

The second electrode member 11X includes a second substrate 100X and the second active material layer 200B. The second substrate 100X includes a second resin substrate 120 and a second conductive layer 125. The second resin substrate 120 includes a first portion 121 and a second portion 122. The first portion 121 is located in each of the flat portions 91 in the wound electrode assembly. The second portion 122 is located in each of the curved portions 92.

The second resin substrate 120 is made of a thermosetting resin such as phenol resin, epoxy resin, melamine resin, urea resin, polyurethane resin, unsaturated polyester resin, diallyl phthalate resin, silicone resin, or polyimide resin.

In order to maintain the wound state of the wound electrode assembly, the flat portions 91 are sandwiched between a pair of substantially flat heating portions during manufacturing. Therefore, the heating portions contact the flat portions 91 but are less likely to contact the curved portions 92. In such a case, heat is less likely to be transferred to the curved portions 92. Moreover, in the curved portions 92, heat is less easily transferred to the radially inner side than to the radially outer side.

Accordingly, the first portion 121 is in a cured state, and the second portion 122 includes a semi-cured region where the thermosetting resin is semi-cured. The outermost portions of the curved portions 92 have a larger proportion of the semi-cured region than the innermost portions of the curved portions 92.

Among the thermosetting resins mentioned above, it is preferable to use a thermosetting resin having a curing temperature higher than 110° C. The manufacturing process of the wound electrode assembly includes a step of drying the wound electrode assembly at 110° C. or lower. Accordingly, the use of a thermosetting resin having a curing temperature higher than the drying temperature of 110° C. reliably allows the semi-cured region to remain in the curved portions 92.

In the unwound state, the second resin substrate 120 is in the form of a sheet extending in the longitudinal direction, and the first portions 121 and the second portions 122 are alternately arranged along the longitudinal direction. The first portions 121 have substantially the same length in the longitudinal direction. On the other hand, the lengths of the second portions 122 in the longitudinal direction gradually decrease from one side toward the other side in the longitudinal direction. The one side in the longitudinal direction corresponds to the outer end side of the wound electrode assembly, and the other side in the longitudinal direction corresponds to the inner end side of the wound electrode assembly.

The second conductive layer 125 is provided on a surface of the second resin substrate 120. Specifically, the second resin substrate 120 has a first surface 120a and a second surface 120b arranged in its thickness direction, and the second conductive layer 125 is provided on each of the first surface 120a and the second surface 120b.

The second conductive layer 125 is provided so as to extend across all of the first portions 121 and the second portions 122 from the one side to the other side in the longitudinal direction.

The second conductive layer 125 is a metal member containing aluminum. The second conductive layer 125 may be formed on the first surface 120a and the second surface 120b by vapor deposition etc. The second conductive layer 125 may be made of metal foil, and may be bonded to the first surface 120a and the second surface 120b by an adhesive.

The second active material layer 200B is provided on a main surface of the second conductive layer 125 located on the opposite side of the second conductive layer 125 from the second resin substrate 120. Specifically, the second conductive layer 125 provided on each of the first surface 120a and the second surface 120b of the second resin substrate 120 has the main surface on the opposite side from the second resin substrate 120. The second active material layer 200B is provided on the main surface of each of the second conductive layers 125.

The wound electrode assembly of the second embodiment having the above configuration also has substantially the same effects as those of the wound electrode assembly 10 of the first embodiment. Moreover, since the thermosetting resin in the second electrode member 11X is also in the cured state in the flat portions 91. Accordingly, elongation of the second resin substrate 120 is suppressed. As a result, the possibility of loose winding of the wound electrode assembly can be more effectively reduced.

Furthermore, in the curved portions 92, the second resin substrate 120 has the semi-cured region where the thermosetting resin is semi-cured. Accordingly, the curved portions 92 can be softened as a whole. It is therefore possible to suppress breakage of the second resin substrate 120 in addition to the first resin substrate 110 in the curved portions 92.

### Other Modifications

In the first and second embodiments, the first electrode member 11A is a cathode and the second electrode member 11B is an anode. However, the present disclosure is not limited to this. The first electrode member 11A may be an anode, and the second electrode member 11B may be a cathode. In this case, each of the members constituting the first electrode member 11A and the second electrode member 11B is selected to suit the polarity of the corresponding substrate.

The embodiments disclosed herein are illustrative in all respects and are not restrictive. The scope of the present disclosure is set forth in the claims, and includes all modifications that fall within the meaning and scope equivalent to the claims.

What is claimed is:

1. A wound electrode assembly in which a first electrode member and a second electrode member having a different polarity from the first electrode member are wound in a flat shape with a separator interposed between the first and second electrode members, the wound electrode assembly including a pair of flat portions and a pair of curved portions, the flat portions facing each other across a winding center, one of the curved portions connecting ends on one side of the flat portions, and the other curved portion connecting ends on the other side of the flat portions, wherein:
the first electrode member includes a first resin substrate, a first conductive layer provided on a surface of the first resin substrate, and a first active material layer provided on a main surface of the first conductive layer, the main surface being located on an opposite side of the first conductive layer from the first resin substrate;
the first resin substrate is made of a thermosetting resin;
a portion of the first resin substrate located in the flat portions is in a cured state in which the thermosetting resin is cured; and
a portion of the first resin substrate located in the curved portions includes a semi-cured region where the thermosetting resin is semi-cured.

2. The wound electrode assembly according to claim 1, wherein outermost portions of the curved portions have a larger proportion of the semi-cured region than innermost portions of the curved portions.

3. The wound electrode assembly according to claim 1, wherein the thermosetting resin has a curing temperature higher than 110° C.

4. The wound electrode assembly according to claim 3, wherein the second electrode member includes a metal substrate and a second active material layer provided on a surface of the metal substrate.

5. The wound electrode assembly according to claim 3, wherein the second electrode member includes a second resin substrate, a second conductive layer provided on a surface of the second resin substrate, and a second active material layer provided on a main surface of the second conductive layer, the main surface being located on an opposite side of the second conductive layer from the second resin substrate.
